(19) United States
(12) Patent Application Publication
(10) Pub. No.: US 2013/0334377 A1
(43) Pub. Date: Dec. 19, 2013

(54) Support Frame for a Pet Feeder

(71) Applicant: CHIH-CHING LEE, Taipei City (TW)

(72) Inventor: CHIH-CHING LEE, Taipei City (TW)

(21) Appl. No.: 13/517,885

(22) Filed: Jun. 14, 2012

(51) Int. Cl. A01K 29/00

(52) U.S. Cl. 248/146

(57) ABSTRACT

A support frame for a pet feeder includes a fastening element, a plurality of accommodating bodies, a carrying element, a supporting element, an upper cover, a base, a supporting seat, a plurality of anti-slip blocks, and a shaft bolt. A user can hold the fastening element to lift up the whole support frame for a pet feeder. The carrying element has a plurality of C-shaped accommodating portions arranged like pedals for allowing the accommodating bodies to be disposed therein respectively. The base is formed with an accommodating trough for allowing a liquid to be received therein to thereby prevent ants or other insects from crawling into the pet food received in the accommodating bodies. Thus, the pets can eat the pet food more conveniently and safely.

### BACKGROUND OF THE INVENTION

1. Field of the Invention

The invention relates to a support frame for a pet feeder, and in particular to a support frame for a pet feeder whereby a pet owner can breed more pets conveniently and the invasion of insects into the pet food can be prevented.

2. Description of Prior Art

With the decreasing birth rate, more and more people like to breed a pet. In order to take care of pets, various technologies and appliances relating to breed the pets are developed and widely used nowadays.

Since the relationship between the pet owner and the pets is much closer and one pet owner may simultaneously breed several pets, these pets may compete for the pet food when the pet owner is breeding, so that the pet owner may not know what to do in dealing with this situation. Further, in order to make the pet to eat or drink more comfortably, the pet owner often uses a stand to lift a pet bowl from the ground. However, the conventional support frame for a pet feeder merely allows the pet bowl to be lifted, but not allows for the convenience in accessing the pet bowls. On the other hand, some pet owners may put a container on the ground and put the pet food into the container. As a result, ants or other insects often crawl into the container to contaminate the pet food. The pet often does not distinguish whether the pet food is contaminated or not and still eat it.

### SUMMARY OF THE INVENTION

The support frame for a pet feeder of the invention is further characterized in that: the number of the accommodating portions of the carrying element is at least two. The accommodating bodies are disposed in the accommodating portions respectively.

The support frame for a pet feeder of the invention is further characterized in that: both ends of the supporting element are formed with a protruding block to correspond to the carrying element and the upper cover respectively.

The support frame for a pet feeder of the invention is further characterized in that: the base is provided with an accommodating trough.

The support frame for a pet feeder of the invention is further characterized in that: the accommodating trough of the base is formed with a protrusion to correspond to the upper cover.

The support frame for a pet feeder of the invention is further characterized in that: the shaft bolt sequentially penetrates the supporting seat, the accommodating trough, the upper cover, the supporting element and the carrying element to be fixed into the fastening element.

The detailed description and technical contents of the invention will be described with reference to the accompanying drawings.

In order to solve the above problems in prior art, an objective of the invention is to provide a support frame for a pet feeder including a fastening element, a plurality of accommodating bodies, a carrying element, a supporting element, an upper cover, a base, a supporting seat, a plurality of anti-slip blocks and a shaft bolt. The fastening element has a well-designed profile for generating a better aesthetic effect and also functions as a carrying handle. Thus, the pet owner can carry the whole support frame for a pet feeder by carrying the fastening element with his/her hand. Thus, if the pet owner raises a plurality of pets, the pet owner can carry two support frame for a pet feeders with his/her both hands for breeding these pets simultaneously. (I) The pet bowls are arranged to surround the fastening element like petals, so that the pets can comfortably eat the pet food in one corresponding pet bowl without getting crowded. (II) The carrying element has C-shaped openings to form a plurality of hollow accommodating portions for allowing a plurality of accommodating bodies (i.e., the pet bowls) to be accommodated therein. The C-shaped opening of the carrying element makes the pe owner to take the accommodating bodies out of the accommodating portions or put them back more easily and conveniently. (III) An accommodating trough is formed between the base and the upper cover. The accommodating trough is used to accommodate a liquid to thereby prevent ants or other insects from crawling into the accommodating bodies to contaminate the pet foods therein. Therefore, according to the support frame for a pet feeder of the invention, a plurality of pet bowls can be accommodated simultaneously for breeding more pets. Further, the invasion of insects into the pet bowls can be prevented. By this arrangement, the pet owner can breed the pets more conveniently and the quality of pet foods can be maintained.

### BRIEF DESCRIPTION OF THE DRAWINGS

FIG. 1 is a perspective view showing the structure of the support frame for a pet feeder according to the embodiment of the invention;

FIG. 2 is an exploded perspective view showing the structure of the support frame for a pet feeder according to the embodiment of the invention;

FIG. 3 is a cross-sectional view showing the base of the support frame for a pet feeder according to the embodiment of the invention;

FIG. 4 is a schematic view showing the carrying element and the accommodating bodies of the support frame for a pet feeder according to an embodiment of the embodiment of the invention;

FIG. 5 is a schematic view showing the carrying element and the accommodating bodies of the support frame for a pet feeder according to an embodiment of the embodiment of the invention; and

FIG. 6 is a schematic view showing the carrying element and the accommodating bodies of the support frame for a pet feeder according to an embodiment of the embodiment of the invention.

### DETAILED DESCRIPTION OF THE INVENTION

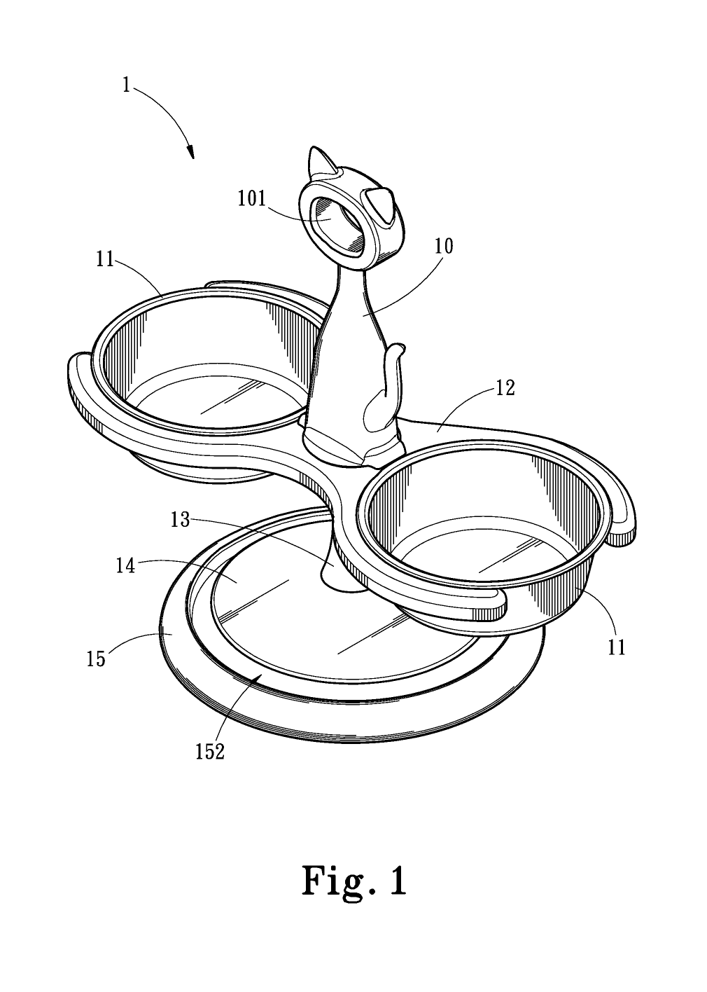

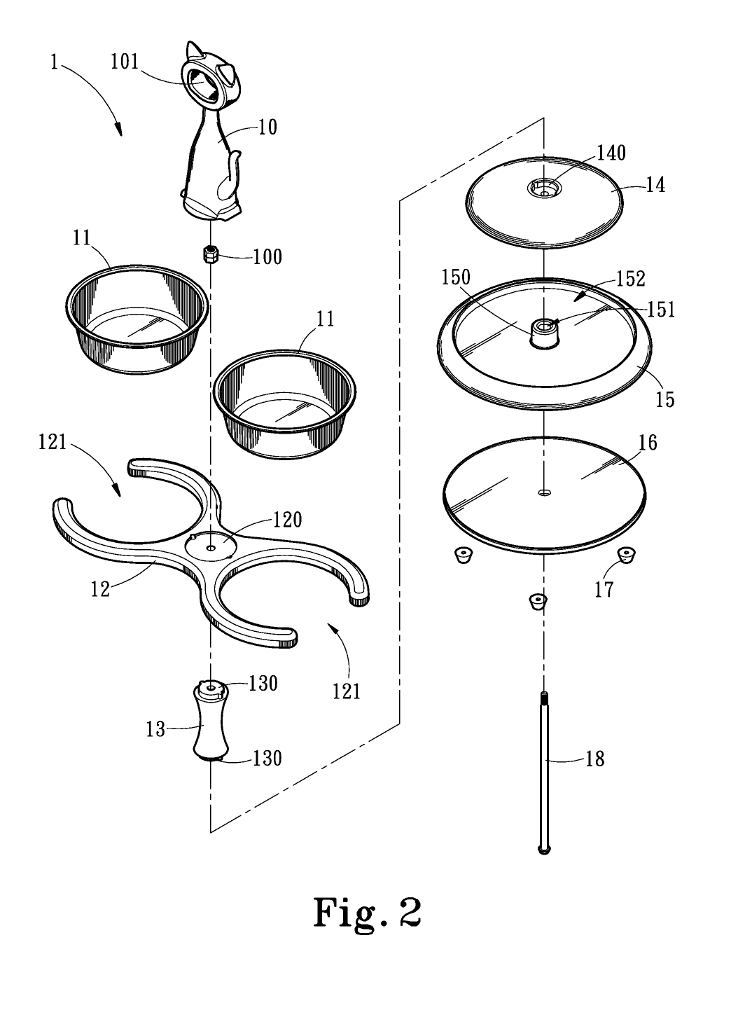

First, please refer to FIGS. 1 and 2. The invention provides a support frame for a pet feeder 1 including a fastening element 10, a plurality of accommodating bodies 11, a carrying element 12, a supporting element 13, an upper cover 14, a base 15, a supporting seat 16, a plurality of anti-slip blocks 17, and a shaft bolt 18. The fastening element 10 is shaped as a pet such as a cat and allows the shaft bolt 18 to be axially fixed thereto. The fastening element 10 may be shaped as other pets rather than the cat, and it is provided with a through-hole 101 whereby a user can lift up the whole support frame for a pet feeder 1. The accommodating bodies 11 are containers disposed in accommodating portions 121 of the carrying element 11 respectively, in which pet food or liquid (e.g. water) is received. The carrying element 12 is configured as a carrier having a plurality of C-shaped accommodating portions 121 in which the accommodating bodies 11 are disposed respectively. The upper surface of the carrying element 12 is formed with an engaging trough 120 for allowing the fastening element 10 to be engaged therein. The C-shaped accommodating portions 121 allow the user to take out the accommodating bodies 11 or put the accommodating bodies 11 back more easily.

The supporting element 13 is formed like a post. The front and rear ends of the supporting element 13 are formed with a protruding block 130 respectively to correspond to the lower surface of the carrying element 12 and an insertion trough 140 of the upper cover 4. The upper cover 14 is provided with an insertion trough 140 for allowing the protruding block 130 of the supporting element 13 to be inserted therein. The upper cover 14 is located to correspond to the base 15. The base 15 is formed like a recessed disk. The interior of the base 15 is provided with an accommodating trough 152. The center of the accommodating trough 152 is provided with a protrusion 150 having a through-hole 151. The protrusion 150 is located to correspond to the center of the upper cover 14. The bottom surface of the base 15 allows the supporting seat 16 to be assembled with.

The supporting seat 16 is arranged on one side (i.e., lower side) of the base 15 for supporting the weight of the base 15 stably. One surface (i.e., the lower surface) of the supporting seat 16 is provided with the plurality of anti-slip blocks 17. Each of the anti-slip blocks 17 is formed as a plastic block on the lower surface of the supporting seat 16.

The shaft bolt 18 is used to serially connect the respective components of the support frame for a pet feeder 1. More specifically, the shaft bolt 18 sequentially penetrates the supporting seat 16, the base 15, the upper cover 14, the supporting element 13, the carrying element 12 and a nut 100 to be fixed into the fastening element 10, thereby constituting the whole support frame for a pet feeder 1.

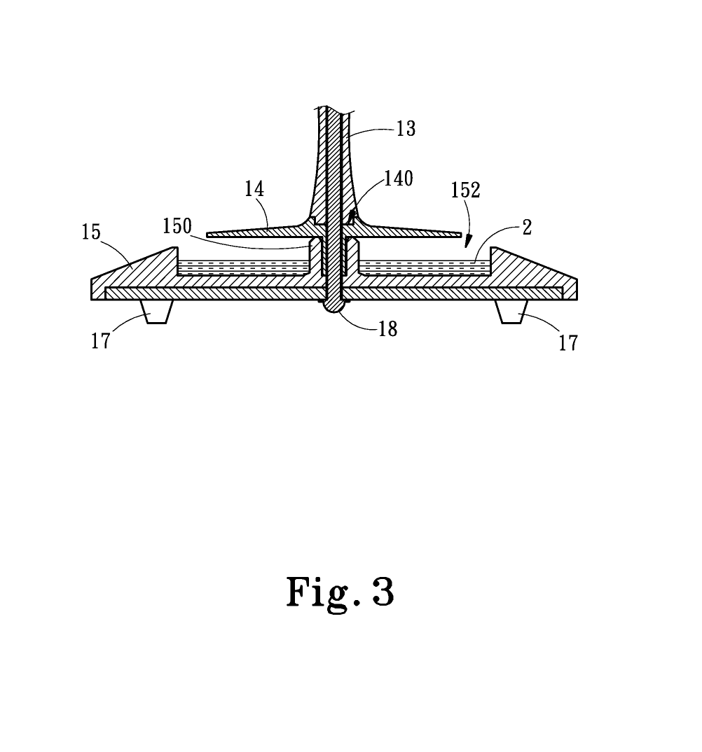

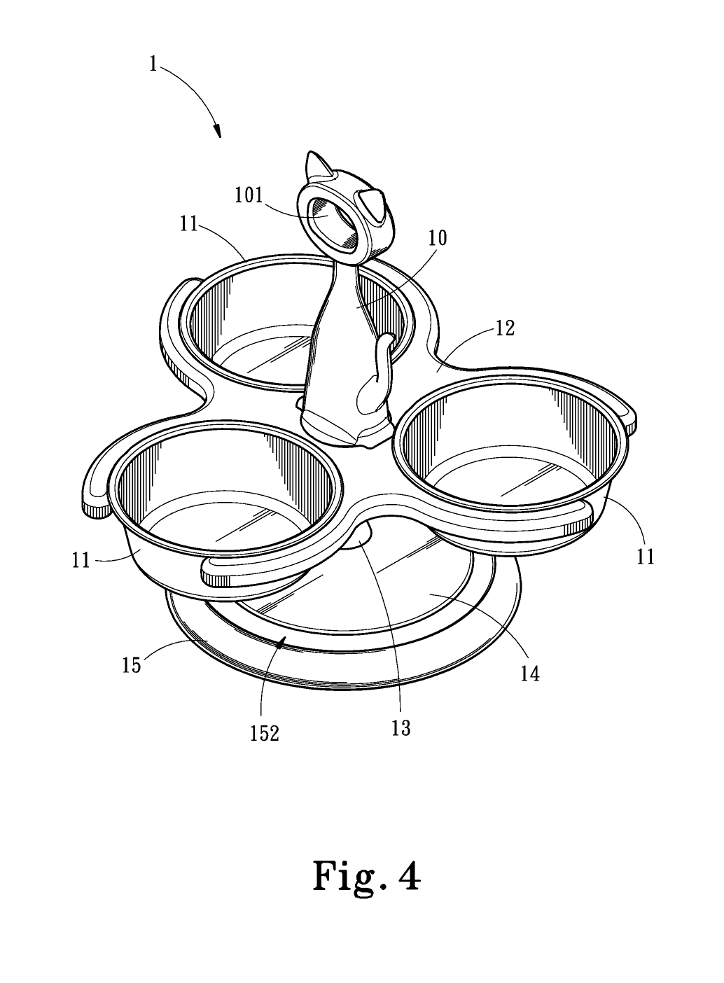

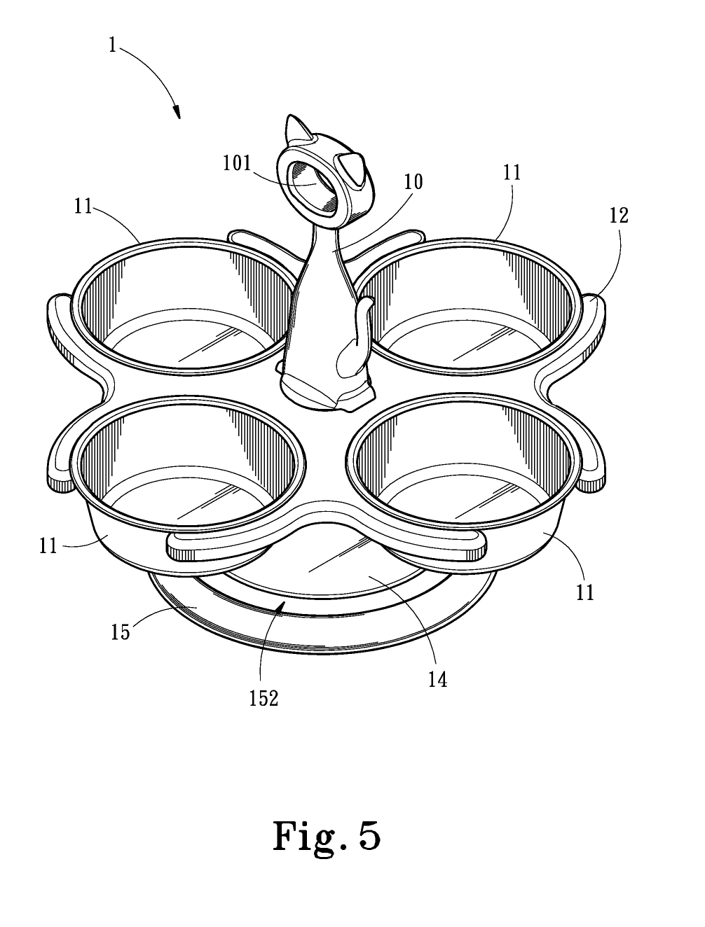

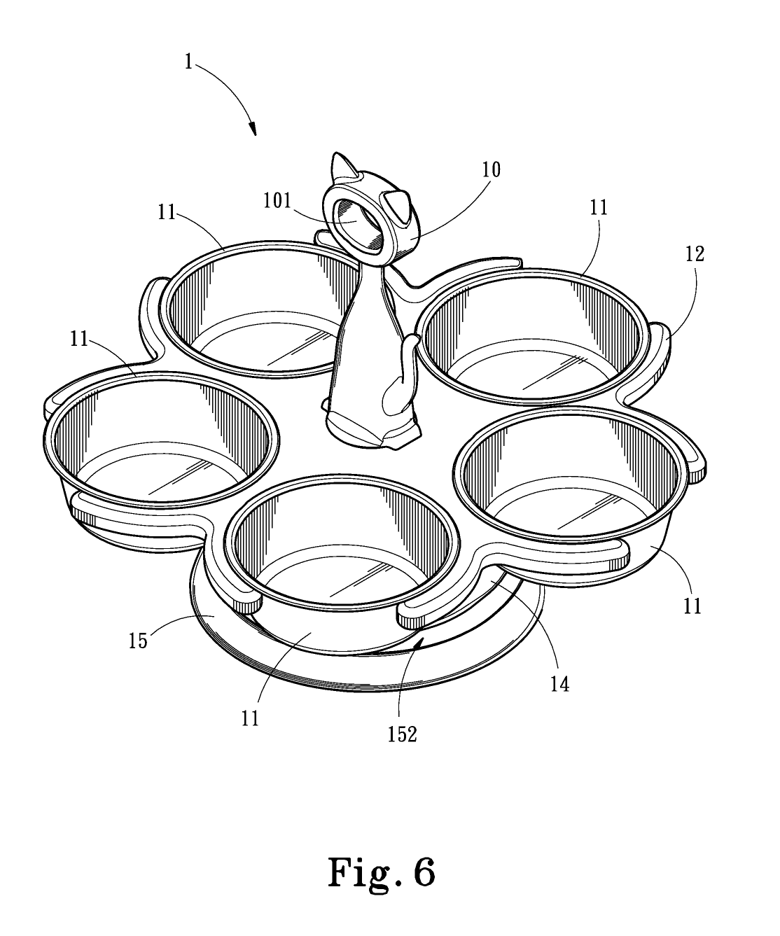

Please also refer to FIGS. 3 to 6. The center of the base 15 is provided with a protrusion 150 for allowing the upper cover 14 to be connected therewith. The accommodating trough 152 formed on the base 15 allows a liquid 2 (e.g. water) to be disposed therein, so that the pet can drink the liquid 2. The liquid 2 also prevents ants or other insects from crawling into the pet food received in the accommodating bodies 11 along the upper cover 14 and the supporting element 13. Further, the number of the accommodating portions 121 of the carrying element 12 can be changed based on practical demands, so that the corresponding number of accommodating bodies 11 can be disposed therein. As shown in FIGS. 4 to 6, the number of the accommodating portions 121 of the carrying element 12 may be three, four, or five based on different needs.

Although the invention has been described with reference to the foregoing preferred embodiments, it will be understood that the invention is not limited to the details thereof. Various equivalent variations and modifications can still occur to those skilled in this art in view of the teachings of the invention. Thus, all such variations and equivalent modifications are also embraced within the scope of the invention as defined in the appended claims.

What is claimed is:

1. A support frame for a pet feeder, including a fastening element, a plurality of accommodating bodies, a carrying element, a supporting element, an upper cover, a base, a supporting seat, a plurality of anti-slip blocks, and a shaft bolt;
characterized in that:
the shaft bolt upwardly penetrates the supporting seat, the base, the upper cover, the supporting element and the carrying element to be fixed into the fastening element, the carrying element is provided with a plurality of C-shaped accommodating portions arranged radially for allowing the accommodating bodies to be disposed therein respectively, the base is formed with an accommodating trough for allowing a liquid to be received therein.

2. The support frame for a pet feeder according to claim 1, wherein the number of the accommodating portions of the carrying element is at least two.

3. The support frame for a pet feeder according to claim 1, wherein both ends of the supporting element are formed with a protruding block to correspond to the carrying element and the upper cover respectively.

4. The support frame for a pet feeder according to claim 1, wherein the accommodating trough of the base is formed with a protrusion to correspond to the upper cover.

5. The support frame for a pet feeder according to claim 1, wherein the anti-slip blocks are provided on one surface of the supporting seat.

6. The support frame for a pet feeder according to claim 1, wherein the number of the accommodating bodies is at least two.

7. The support frame for a pet feeder according to claim 1, wherein the fastening element is provided with a through-hole.
